(19) United States
(12) Patent Application Publication
(10) Pub. No.: US 2003/0046424 A1
(43) Pub. Date: Mar. 6, 2003

(54) Computer switcher allowing data exchange among multiple computers, data exchange system using the computer switcher, and data exchange program

(75) Inventor: Mitsuru Kobayashi, Shinagawa (JP)

Correspondence Address: STAAS & HALSEY LLP, 700 11TH STREET, NW, SUITE 500, WASHINGTON, DC, 20001, US

(73) Assignee: NAGANO FUJITSU COMPONENT LIMITED, Nagano (JP)

(21) Appl. No.: 10/147,072

(22) Filed: May 17, 2002

(30) Foreign Application Priority Data
Sep. 5, 2001 (JP) 2001-269469

(51) Int. Cl. G06F 15/173; G06F 15/16

(52) U.S. Cl. 709/238; 709/250

(57) ABSTRACT

A data exchange system comprises a plurality of computers and a computer switcher connected to each of the computers. Each computer has a data exchanger configured to generate a data transfer request. The computer switcher has an interface controller configured to receive the data transfer request from a first computer, obtain requested data from a second computer or from data storage, and supply the requested data to the first computer.

### BACKGROUND OF THE INVENTION

1. Field of the Invention

The present invention generally relates to a computer switcher, which is inserted between computers and a set of user interfaces including a monitor, a keyboard, and a mouse, in order to allow multiple computers to exchange data through manipulation of the single set of user interfaces.

2. Description of the Related Art

Computer switchers that allow users to switch operations among multiple computers have conventionally existed. A conventional computer switcher is inserted between computers and a user interface, such as a keyboard, a mouse, a monitor, etc. The user can operate multiple computers by switching the user interface to a desired computer through switch manipulation.

When operating multiple computers via a computer switcher, demand for transferring data from one computer to another computer often arises. With a conventional computer switcher, the computers have to be connected to one another via a LAN (local area network) for the purpose of data transfer, or alternatively, recording media such as flexible disks or magneto-optical disks are used to share the data among the computers.

However, establishing a LAN between the computers requires additional appliances, such as LAN boards, HUBs, and cables, and consequently, extra cost and labor are incurred. Concerning recording media, flexible disks are not practical because the storage capacity is insufficient and the operation speed is slow. Using magneto-optical disks requires as many reading devices as computers connected to the system, and therefore, it also has a high cost.

It may be possible for a keyboard and a mouse (i.e., PS/2 interface) to be used as a tool for transferring data in a computer system with the conventional computer switcher. However, such a user interface is unsuitable for a large amount of data transfer. This is because the data transfer speed of the user interface is inherently slow. In addition, using the user interface, data is transferred within time slots between transmitting commands for keyboard or mouse manipulation, which further deteriorates data transfer speed. Therefore, it is desirable to insert a high-speed interface between the computer switcher and the connected computers.

Another problem is that the conventional computer switcher requires the typer speed and the mouse pointer speed of the computers connected to the switcher to be equal to each other. If the keyboard typer speed or the mouse pointer speed is different between computers, the user may feel incompatibility when switching computers, and operation error may occur. Furthermore, the keyboard typermatic time and the mouse pointer speed must be set separately for each computer connected to the conventional computer switcher. If many computers are connected to the computer switcher, typer speed setup time and the pointer speed setup time become undesirably long.

### SUMMARY OF THE INVENTION

Accordingly, it is a general object of the invention to overcome the above-described problems in the prior art, and to provide a computer switcher that allows a large amount of data transfer among multiple computers at a high speed.

It is another object of the invention to provide a computer switcher that allows parameter values to be simultaneously set up in the operating systems of multiple computers.

To achieve the objects, in one aspect of the invention, a computer switcher is provided. The computer switcher comprises a plurality of terminal ports, each configured to be connected to one of multiple external computers, and an interface controller. The interface controller is configured to receive a data transfer request from one of the computers, obtain data requested by said one of the computers, and supply the requested data to said one of the computers.

The interface controller obtains the requested data by, for example, retrieving the data from a second computer designated by said one of the computers, or alternatively, from data storage. The data storage may be built-in data storage or an external storage medium.

This computer switcher allows the computers to exchange and share data among themselves.

The interface controller also receives a parameter setup value from a first computer, designating a second computer. The interface controller causes the second computer to set up a parameter based on the parameter setup value.

This arrangement allows the parameter value, such as a typer speed or a pointer speed, to be equal among the computers. The user then can switch arbitrary computers connected to the computer switcher in a smooth manner.

In the second aspect of the invention, a data exchange system is provided. The data exchange system comprises a plurality of computers and a computer switcher connected to the computers. Each of the computers has a data exchanger configured to generate a data transfer request. The computer switcher has an interface controller configured to receive a data transfer request from one of the computers, obtain data requested by said one of the computers, and supply the requested data to said one of the computers.

This system realizes efficient data sharing by furnishing the data exchanger in each computer. This arrangement allows the computers connected to the computer switcher to exchange a large amount of data at high speed.

In the third aspect of the invention, a data exchange program installed in a computer connected to a computer switcher is provided. The program comprises a series of instructions for causing the computer to generate a data transfer command requesting a designated computer to transfer desired data to the computer; causing the computer to send the data transfer command to the designated computer via the computer switcher; and causing the computer to receive the desired data from the designated computer via the computer switcher.

Other objects, features, and advantages of the invention will become more apparent from the following detailed description when read in conjunction with the accompanying drawings.

### BRIEF DESCRIPTION OF THE DRAWINGS

FIG. 1 is a schematic diagram of a data exchange system using a computer switcher according to the first embodiment of the invention;

FIG. 2 is a block diagram of the data exchange system illustrated in FIG. 1;

FIG. 3 illustrates a data exchange sequence carried out in the system shown in FIG. 1;

FIG. 4 is a schematic diagram of a data exchange system using a computer switcher according to the second embodiment of the invention;

FIG. 5 is a block diagram of the data exchange system illustrated in FIG. 4;

FIG. 6 illustrates a modification of the data exchange system shown in FIG. 5, which has an interface with an external storage;

FIG. 7 illustrates a data exchange sequence carried out in the system shown in FIG. 4;

FIG. 8 is a schematic diagram of a data exchange system using a computer switcher according to the third embodiment of the invention; and

FIG. 9 illustrates a data exchange sequence carried out in the system shown in FIG. 8.

### DETAILED DESCRIPTION OF THE PREFERRED EMBODIMENTS

Details of the embodiments will now be described with reference to the drawings.

[First Embodiment]

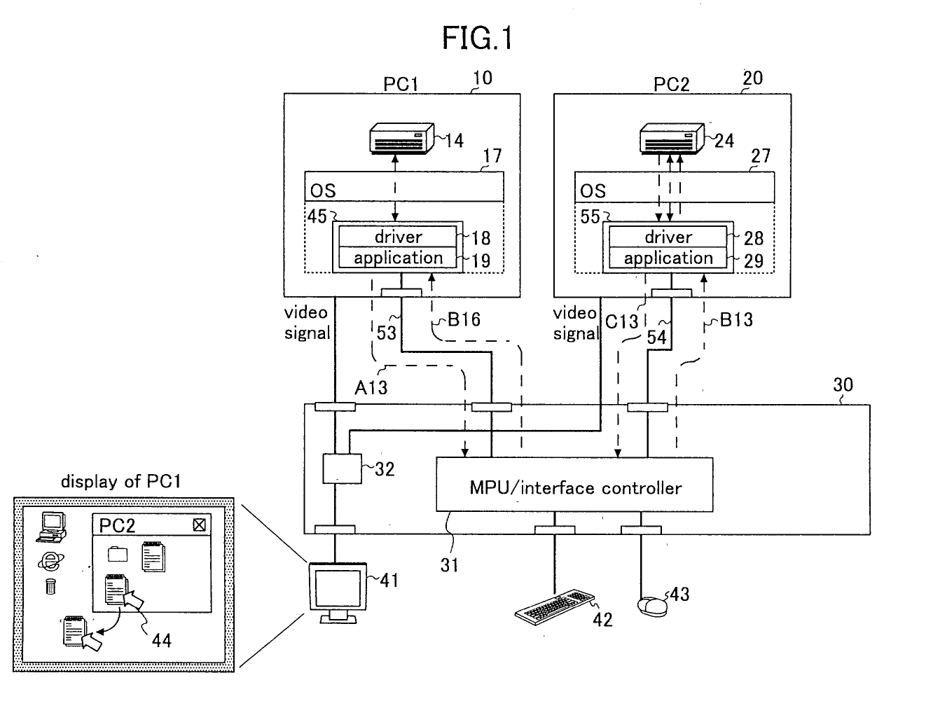

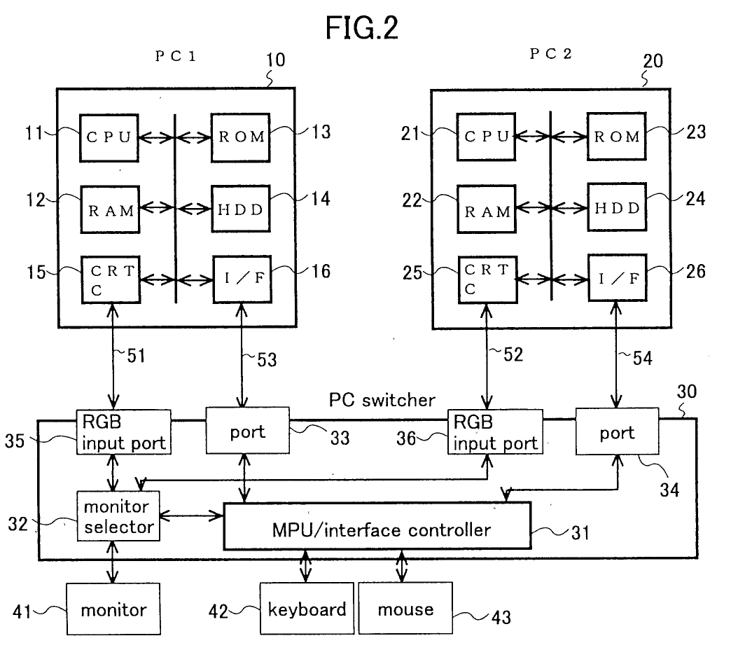

FIGS. 1 and 2 illustrate a date exchange system using a computer switcher according to the first embodiment.

The data exchange system includes a computer switcher 30 and computers (PC1 and PC2) 10, 20 connected to the computer switcher 30. The computer switcher 30 has an MPU/interface controller 31, and is capable of switching the computers 10, 20, while allowing the computers 10, 20 to exchange data with each other. One of the novel features of the computer switcher 30 is to allow the computers to exchange and share data between themselves, in addition to the capability of switching the computers 10, 20.

A monitor 41, a keyboard 42, and a mouse 43 are connected to the computer switcher 30. These user interfaces are shared between the computers 10 and 20. The user can switch between computers 10 and 20 through the computer switcher 30 and work on a desired computer using the keyboard 42 and the mouse 43, while watching the monitor 41.

Each of the computers 10, 20 has a data exchanger 44 (55). If the first computer 10 needs a data file stored in the second computer 20, the data exchanger 45 generates a data transfer request. Similarly, if the second computer 20 requires a data file stored in the first computer 10, the data exchanger 55 generates a data transfer request. The details of generating a data transfer request will be explained below.

Computer (PC1) 10 has a CPU (central processing unit) 11, RAM (random access memory) 12, ROM (read only memory) 13, HDD (hard disk drive) 14, CRT (cathode-ray tube) controller 15, and a communication interface 16, which are connected to each other via a system bus. Similarly, the computer (PC2) 20 has a CPU 21, RAM 22, ROM 23, HDD 24, CRT controller 25, and a communication interface 26, which are also connected to each other via a system bus.

The CPU 11 executes data processing based on programs stored in the ROM 13, and comprehensively controls the devices and units connected to the system bus. The RAM 12 functions as a main memory, a work area, and so on for the CPU 11. The ROM 13 stores various programs and data. The HDD 14 stores various types of application software, driver software, user files, editor files, and system software. The data exchanger 45 including a driver 18 and an application 19 is provided in the HDD 14. If the data exchanger 45 is implemented as a program, the program is also stored in the HDD 14.

The CRT controller 15 controls images displayed on the screen of the monitor 41. The CRT controller 15 supplies video signals to the computer switcher 30 via the cable 53. The interface 16 is connected to the port 33 of the computer switcher 30 via the cable 53, and controls communication between the computer 10 and the computer switcher 30.

Similarly, in the second computer (PC2) 20, the CPU 21 comprehensively controls the devices and units connected to the system bus. The HDD 24 stores various types of application software, driver software, user files, editor files, and system software. The data exchanger 55 including a driver 28 and an application 29 is provided in the HDD 24. If the data exchanger 55 is implemented as a data exchange program, the program is also stored in the HDD 24.

The CRT controller 25 controls the display screen of the monitor 41. The CRT controller 25 supplies video signals to the computer switcher 30 via the cable 54. The interface 26 is connected to the port 34 of the computer switcher 30 via the cable 54, and controls communication between the computer 10 and the computer switcher 30.

The computer (PC1) 10 has an operating system (OS) 17, which operates on the first computer 10. In the first embodiment, the data exchanger 45 is comprised of driver software 18 and application software 19, which are installed in the computer 10 to realize data exchange between the computers 10 and 20. The driver install program is executed by the CPU 11 of the computer 10.

Similarly, the computer (PC2) 20 has an operating system (OS) 27, which operates on the second computer 20. Driver software 28 and application software 29 are installed in the computer 20, and they are used for data exchange between the computers 10 and 20. The driver install program is executed by the CPU 21 of the computer 20.

Data exchangers 45, 55, which are furnished in the first and second computers 10, 20, cooperate with the MPU/interface controller 31 of the computer switcher 30 in order to allow the computers 10 and 20 to transfer data between themselves via the computer switcher 30. As has been described above, each of the data exchangers 45, 55 includes driver software 18 (28) and application software 19 (29), which provide a user interface, such as an icon, to allow the user to access the other computer.

The computer switcher 30 includes a monitor selector 32, communication ports 33, 34, and RGB input ports 35, 36, besides the MPU/interface controller 31. The MPU/interface controller 31 is connected to the interfaces 16, 26 of the first and second computers (PC1 and PC2) 10, 20 via the ports 33, 34. The MPU/interface controller 31 communicates with the data exchangers 44, 45, each of which comprises driver software and application software, to carry out data transfer between the first and second computers 10, 20.

The monitor selector 32 is comprised of, for example, an analog switch, and it selects monitor signals (or video signals) output from the computers (PC1 and PC2) 10, 20 to use in the monitor 41. The monitor selector 32 is under the control of the MPU/interface controller 31. The monitor 41 displays images based on the monitor signals transmitted from the computers 10, 20 and selected by the monitor selector 32.

The ports 33, 34 are connected to the interfaces 16, 26 of the first and second computers (PC1 and PC2) 10, 20 via communication cables 53, 54, respectively. The ports 33, 34 function as terminals, and regulate communication between the computers 10, 20. The first and second computers 10, 20 may be connected to the computer switcher 30 via either a serial interface or a parallel interface. Examples of serial interfaces include, but are not limited to, PS/2 interface, USB interface, and IEEE1394 interface. If using a USB interface or an IEEE1394 interface, the data transfer rate between the computer switcher 30 and the computers 10, 20 is improved, and high-rate data transfer can be achieved. By increasing the number of channels of the computer switcher 30, the number of computers connected to the computer switcher 30 can be increased. The communication cables used to connect additional computers to the computer switcher 30 naturally increase along with the increase of computers.

The RGB input ports 35, 36 are connected to the CRT controllers 15, 25 of the first and second computers 10, 20 via CRT cables 51, 52, respectively, and receive video signals from the computers 10, 20. The output of the RGB input ports 35, 36 are connected to the monitor selector 32, which switches the video signals from the first and second computers 10, 20 to display the images on the monitor display 41.

The keyboard 42 and the mouse 43 allow the user to input various commands and messages. The MPU/interface controller 31 of the computer switcher 30 receives the commands and messages from these user interfaces, and outputs them to the first and second computers 10, 20 via the ports 33, 34.

Although, in the first embodiment, two computers (PC1 and PC2) are connected to the computer switcher 30, three or more computers may be connected to the computer switcher 30.

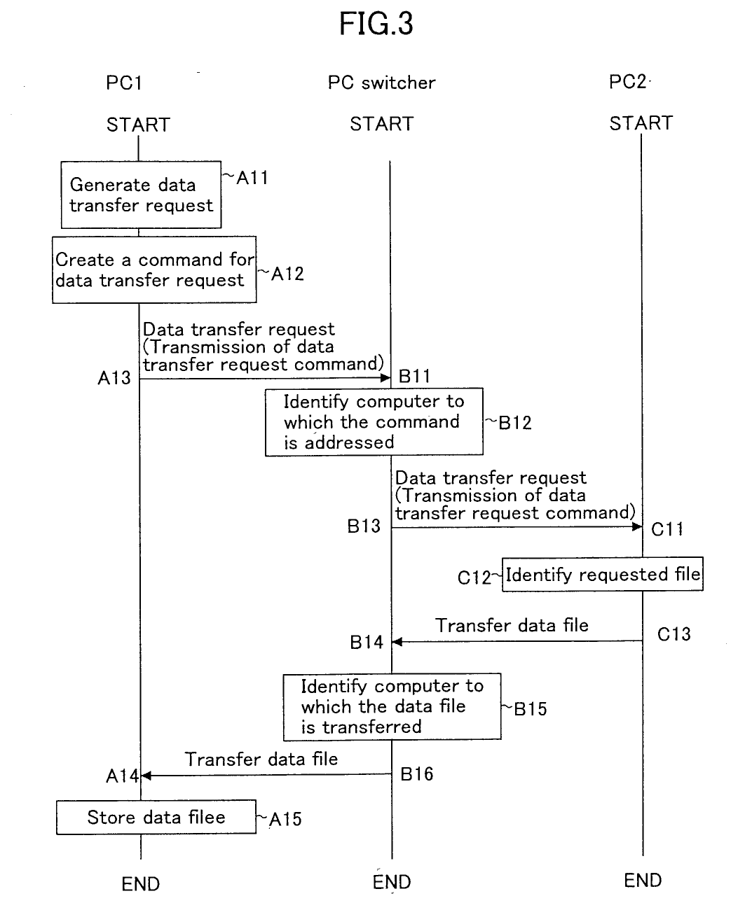

FIG. 3 illustrates an operation sequence of the data exchange system shown in FIGS. 1 and 2. This example shows the situation in which the user who is working on the first computer (PC1) 10 wishes to use a data file stored in the hard disk drive 24 of the second computer (PC2). The operation carried out in the data exchange system will be explained with reference to FIGS. 1-3.

The monitor 41 displays the menu page of the first computer (PC1) 10, as illustrated in FIG. 1. The display screen 41 includes an icon representing the HDD 24 of the second computer (PC2) 20, which is produced by the driver software 18 and the application software 19 of the data exchanger 45. By clicking the icon of the HDD 24 of PC2, a window displaying the file contents of the HDD 24 of PC2 is opened.

If the user selects a data file of PC2 and drags the file to a selected folder (e.g., to a desk top) of PC1 using a pointer 44, the data exchanger 45 of PC 1 generates a data transfer request (A11). To be more precise, the driver software 18 receives a data transfer request from the application software 19, and it creates a command for a data transfer request (A12).

The driver software 18 of the data exchanger 45 then transmits the data transfer request command to the computer switcher 30 via the communication cable 53 (A13). The MPU/interface controller 31 of the computer switcher 30 receives the command from PC 1 (B11), and identifies the designated computer (PC2) to which the command is addressed (B12). Then, the MPU/interface controller 31 supplies the data transfer request command to the exchanger 55 of PC2 (B13).

The driver software 28 of the exchanger 55 of PC2 receives the data transfer request command (C11). The driver software 28 identifies the data file requested by the exchanger 45 of PC1, and extracts the file from the hard disk drive 24 via the operating system 27 (C12). The driver software 28 transmits the file to the computer switcher 30 via the communication cable 54 (C13).

The computer switcher 30 receives the file from PC2 (B14), and the MPU/interface controller 31 identifies the requester to which the file is to be supplied (B15). Then, the MPU/interface controller 31 transfers the file to PC1 via the communication cable 53 (B16).

The driver software 18 of the data exchanger 45 of PC1 receives the target data file from the computer switcher 30 (A14), and stores the file in the hard disk drive 14 of PC1 through the operating system 17 (A15).

In this manner, the data file stored in the second computer (PC2) 20 is transferred to the first computer (PC1) 10 via the computer switcher 30. Since the first and second computers 10, 20 have data exchangers 45, 55, respectively, they can exchange and share desirable data between themselves by only inserting the computer switcher 30 with the MPU/interface controller 31 in the system. The data exchange system does not require LAN or external bulk memory, and the system construction cost can be reduced.

If the data exchangers 45, 55 furnished in the computers 10, 20 are implemented as data exchange programs, such programs comprise the instructions of causing the computer (PC1) to generate a data transfer command requesting a designated computer (PC2) to transfer target data to the computer (PC1); causing the computer (PC1) to transmit the data transfer command to the designated computer (PC2) via the computer switcher 30; and causing the computer (PC1) to receive the target data from the designated computer (PC2) via the computer switcher 30. The program also comprises the instruction of causing the computer (PC1) to store the target file in the memory.

The program may further comprise the instruction of causing the computer (PC1) to receive a data transfer request from a second computer (PC2) via the computer switcher 30, to retrieve a requested file, and to supply the retrieved file to the second computer (PC2) via the computer switcher 30.

In the data exchange system, the user interface, such as the monitor 41, the keyboard 42, and the mouse 43, is shared between the first and second computers 10, 20, and a data transfer request can be specified simply by dragging the icon. The operability is greatly improved.

The computers connected to the computer switcher 30 are not limited to personal computers (PC), and any types of computers can be included in the data exchange system as long as they are connectable with the computer switcher 30.

[Second Embodiment]

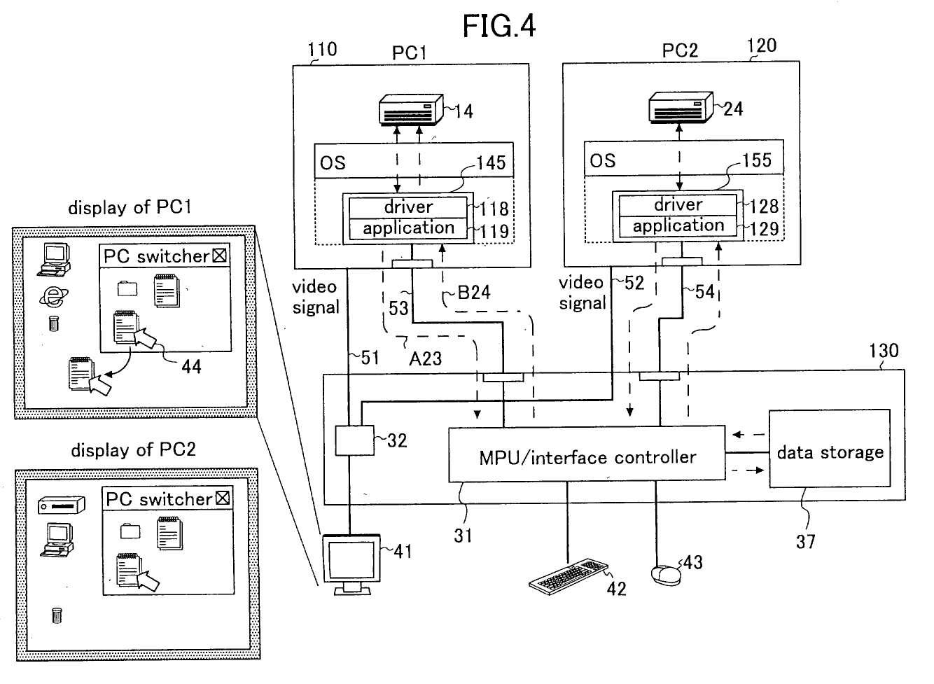

FIGS. 4 through 7 illustrate a data exchange system according to the second embodiment of the invention. In the second embodiment, the computer switcher 130 has a data storage connected to the MPU/interface controller 31. The other components that are the same as those in the first embodiment are denoted by the same reference numerals, and explanation for them will be omitted.

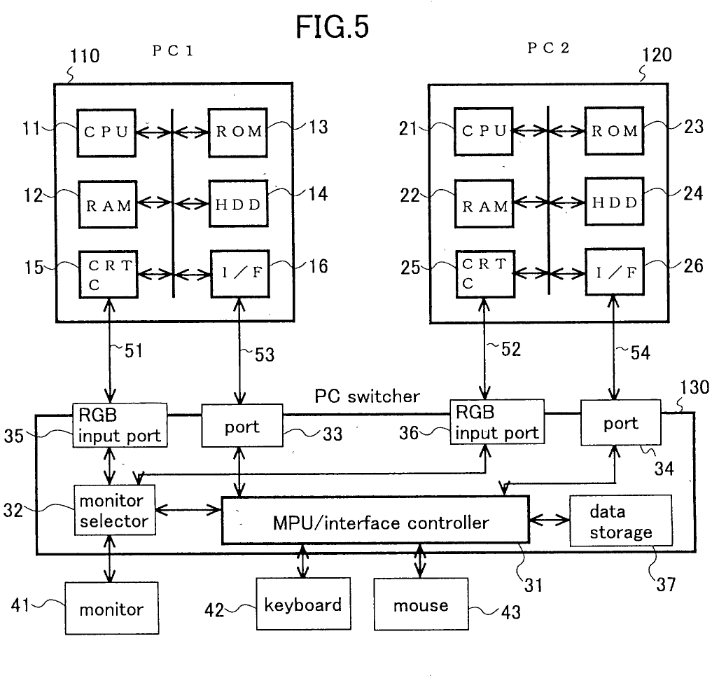

In the example shown in FIGS. 4 and 5, the data storage 37 is a built-in storage, and it stores data shared by the first and second computers 110, 120. The data storage 37 is, for example, a semiconductor memory, a hard disk drive, or any suitable devices for storing data. The first and second computers 110, 120 read and write desired data from and in the data storage 37 under control of the MPU/interface controller 31.

As in the first embodiment, the first and second computers 110, 120 have data exchangers 145, 155, each of which comprises driver software 118 (128) and application software 119 (129). The data exchangers 145, 155 cooperate with the MPU/interface controller 31 of the computer switcher 130 to allow the computers 110, 120 to exchange and share the data stored in the data storage 37.

The data exchangers 145, 155 of the first and second computers 110, 120 create an icon representing the data storage 37 of the computer switcher 130, and cause the monitor 41 to display the icon, as illustrated in FIG. 4.

If the data exchangers 145, 155 are implemented as data exchange programs, such programs are stored in, for example, the hard disk drives 14, 24, and are executed by the CPUs 11, 12 of the first and second computers 110, 120.

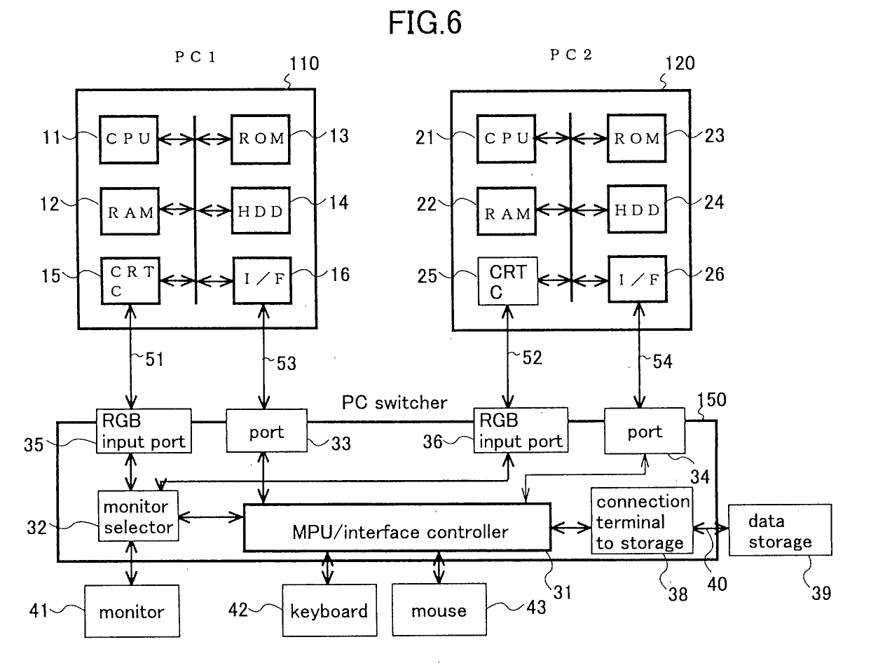

FIG. 6 illustrates a modification of the data exchange system of the second embodiment. In FIG. 6, the system includes external (detachable) data storage 39, in place of the built-in data storage 37. In this case, the computer switcher 150 has a connection jack (or terminal) 38 that receives the external data storage 39. The connection jack 38 is connected to the MPU/interface controller 31. The connection jack 38 and the external data storage 39 may be connected using a communication cable 40. The external data storage 39 is, for example, comprised of removable media, such as flexible disks or MO disks.

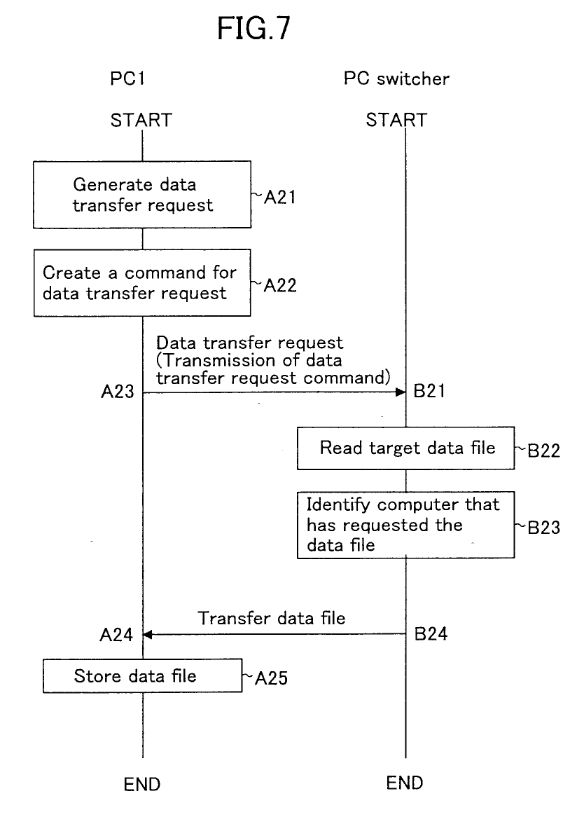

FIG. 7 illustrates an operation sequence of the data exchange system of the second embodiment. In this example, the user working on the first computer (PC1) 110 wishes to use a data file stored in the data storage 37 on the first computer 110.

First, the user clicks the icon representing the data storage 37 of the computer switcher 130. Then, a window is opened in the screen page of the first computer (PC1) 110 on the monitor 41. By dragging a target file from the window to a selected folder (e.g., to a desk top) using the pointer 44, a data transfer request is generated in the application software 119 of the data exchanger 145 of PC1 (A21). The driver software 118 receives the data transfer request from the application software 119, and creates a command for data transfer request (A22).

The driver software 118 of the data exchanger 145 transmits the command to the computer switcher 130 (A23), and the MPU/interface controller 31 of the computer switcher 130 receives the command (B21). The MPU/interface controller 31 then retrieves the requested data file in the data storage 37 of the computer switcher 130 based on the command, and reads the data file (B22).

The MPU/interface controller 31 identifies the requester (PC1) to which the data file is to be supplied (B23), and transfers the data file to the data exchanger 145 of PC1 (B24) via the communication cable 53. The driver software 118 of the data exchanger 145 of PC1 receives the data file from the computer switcher 130 via the port 33 (A24), and stores the data in the hard disk drive 14 via the operating system 17 (A25). At this point of time, the data file of the data storage 37 has been copied in the desk top of PC1.

If the second computer (PC2) 120 requests a data file stored in the data storage 37, the same process is carried out. In this case, the operation is switched to the second computer (PC2) 120 through the computer switcher 130, and the monitor 41 displays the screen page of PC2, as illustrated in FIG. 4. The user can open a window of data storage 37 of the computer switcher 130 on the monitor 41, and specify which data file is to be transferred to the second computer (PC2). In this manner, the first and second computers 110 and 120 can exchange and share the data via the computer switcher 130.

If the data exchanger 145 of the second embodiment is implemented as a data exchange program, the program comprises the instructions of causing the computer to generate a data transfer command requesting the computer switcher 130 to retrieve a target data file in the data storage 37 (or 39); causing the computer to send the data transfer command to the computer switcher 130; and causing the computer to receive the target data from the computer switcher 130.

[Third Embodiment]

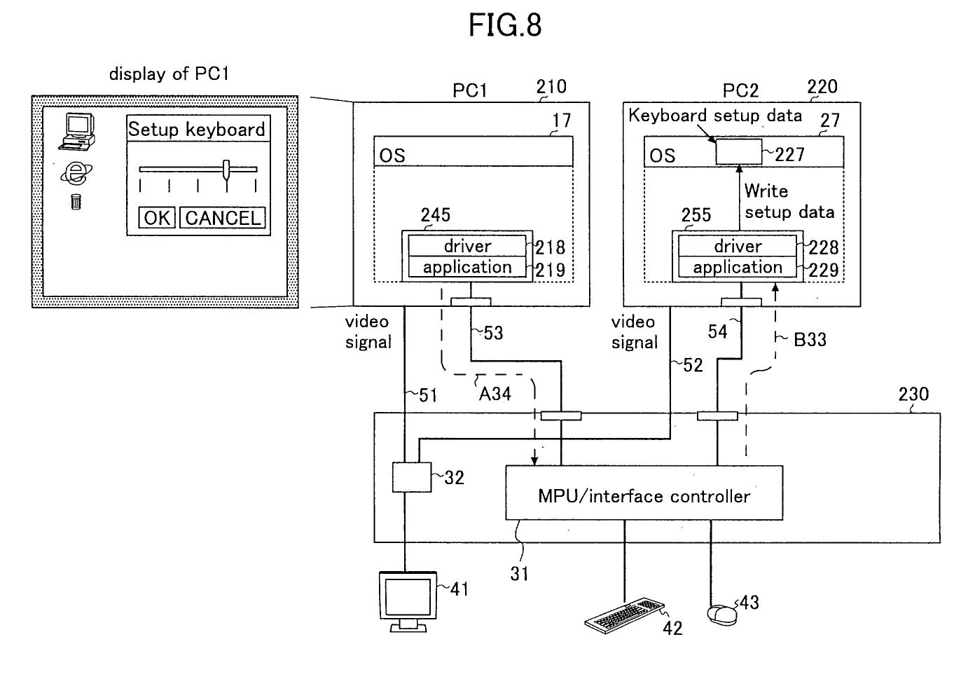

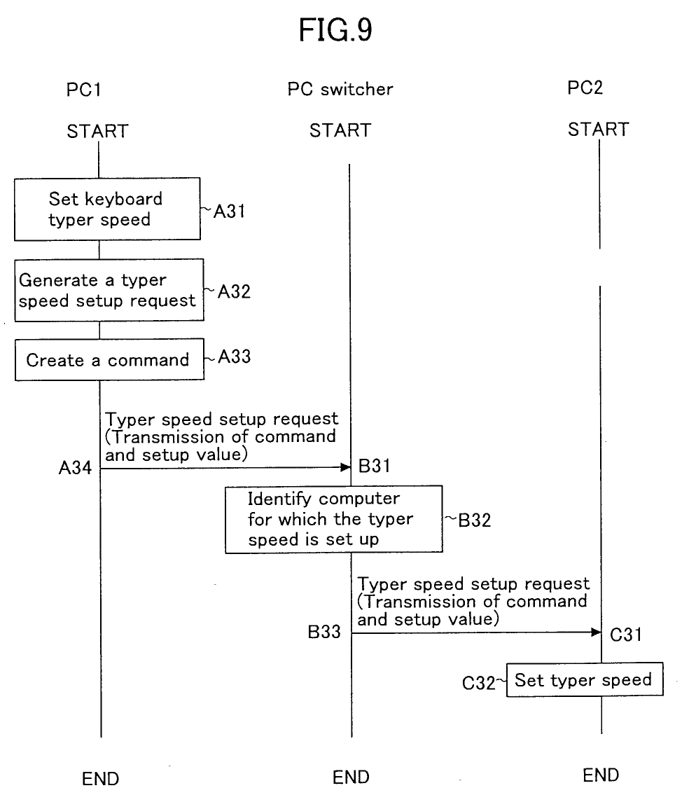

FIGS. 8 and 9 illustrate a data exchange system according to the third embodiment. The data exchange system of the third embodiment can comprehensively set up operation parameters in the computers connected to the computer switcher 230. In other words, the parameters of the user interface (e.g., the keyboard, the mouse, etc.) set in the operating system of a computer are supplied to the other computers via the computer switcher 230 so as to make the parameters equal among the computers in the data exchange system. In the following, explanation will be made using the keyboard typer speed or the mouse pointer speed as an example of the parameter; however, the invention is not limited to the example. The data exchange system of the third embodiment can set any parameters equal among the computers as long as such parameters can be treated in the operating system.

The first and second computers 210, 220 have data exchangers 245, 255, each of which is comprised of a driver 218 (228) and an application 219 (229). The data exchanger 245 sets the parameters of the user interface of the first computer (PC1) 210 to preferable values, and transmits the new values to the computer switcher 230. The MPU/interface controller 31 of the computer switcher 230 supplies the new values for the parameters to all the other computers included in the data exchange system. The other computers set the parameters based on the received values, thereby equalizing the parameters among the computers.

If the data exchanger 145 is implemented as a data exchange program, it is stored in the HDD 14, and executed by the CPU 11 of PC1. The same applies to the second computer (PC2).

FIG. 9 illustrates an operation sequence of the data exchange system shown in FIG. 8. In this example, the typer speed of the keyboard 42 selected by the first computer (PC1) 210 is supplied to the second computer (PC2) 220 via the computer switcher 230 in order to make the parameter (i.e., the typer speed) equal between the first and second computers 210, 220.

Keyboard parameter setup window is opened on the display 41, as illustrated in FIG. 8. The displayed page is provided by the application software 219 of the first computer (PC1) 210. The user sets the typer speed of the keyboard 42 on the monitor 41, by means of the application software 219 of the data exchanger 245 of PC1 (A31), and a typer speed setup request is generated (A32). The application software 219 designates a target computer (for example, PC2), in which the parameter is to be set to the same value as that selected in the first computer (PC1) 210. Of course, the system may be configured so that the user can designate the target computer arbitrarily.

The driver software 218 creates a command for the typer speed setup request in response to the request generated by the application software 219 (A33). The driver software transmits the command and the parameter setup value to the computer switcher 230 via the communication cable 53 (A32). The MPU/interface controller 31 of the computer switcher 230 receives the command and the parameter setup value from the driver software 219 of PC1 (B31), and identifies the target computer (PC2 in this example) in which the typer speed is to be set to the selected value (B32). Then, the computer switcher 230 transfers the command and the parameter setup value to the second computer (PC2) 220 via the communication cable 54 (B33).

The driver software 228 of the second computer (PC2) 220 receives the command and the parameter setup value from the computer switcher 230 (C31). Then, the driver software 228 of PC2 writes the typer speed set up value for the keyboard in the operating system 27, thereby setting this parameter to be equal to that of the first computer (PC1) 210 (C32). In this example, only two computers 210 and 220 are connected to the computer switcher 230, and therefore, the parameter setup value is transmitted only to the second computer (PC2) 220. However, if three or more computers are connected, the parameter setup value selected by the first computer 210 is transmitted to some or all of the other computers via the computer switcher 230. The data exchanger (e.g., the application software) of the first computer (PC1) may designate any desirable computers as the target computer in which the parameter must be set equal. This arrangement realizes efficient parameter-setting operations, and can eliminate operational incompatibility between the computers.

The present invention is not limited to these embodiments, but various substitutions and modifications may be made without departing from the scope of the invention.

This patent application is based on Japanese priority patent application No. 2001-269469 filed on Sep. 5, 2001, the entire contents of which are hereby incorporated by reference.

What is claimed is:

1. A computer switcher comprising:
a plurality of terminal ports, each configured to be connected to one of a plurality of external computers, respectively; and
an interface controller configured to switch the terminal ports and allow the external computers to exchange data with one another.

2. A computer switcher comprising:
a plurality of terminal ports, each configured to be connected to one of a plurality of external computers, respectively; and
an interface controller configured to receive a data transfer request from a first external computer via a first terminal port, obtain data requested by the first external computer, and supply the requested data to the first external computer via the first terminal port.

3. The computer switcher according to claim 2, wherein the interface controller supplies the data transfer request to a second external computer to which the data transfer request is addressed via a second terminal port, receives the requested data from the second external computer via the second terminal port, and transfers the requested data to the first external computer via the first terminal port.

4. The computer switcher according to claim 2, further comprising a data storage connected to the interface controller and configured to store data to be shared among the external computers, wherein the interface controller retrieves the requested data in the data storage and supplies the retrieved data to the first computers.

5. The computer switcher according to claim 2, further comprising a connection terminal connected to the interface controller and configured to receive an external storage medium, wherein the interface controller retrieves the requested data from the external storage medium via the connection terminal.

6. The computer switcher according to claim 2, wherein the interface controller is configured to further receive a parameter setup value from one of the external computer and to cause a second external computer to set up a parameter based on the parameter setup value.

7. The computer switcher according to claim 6, wherein the interface controller causes other external computers to each set up the parameter based on the parameter setup value.

8. A data exchange system comprising:
a plurality of computers, each having an data exchanger configured to generate a data transfer request; and
a computer switcher connected to the computers and having an interface controller configured to receive a data transfer request from one of the computers, obtain data requested by said one of the computers, and supply the requested data to said one of the computers.

9. The data exchange system according to claim 8, wherein the interface controller supplies the data transfer request to a designated computer, and wherein the data exchanger of the designated computer retrieves the requested data and supplies the requested data to the interface controller.

10. The data exchange system according to claim 8 wherein the computer switcher further has a data storage configured to store data to be shared among the computers, and wherein the interface controller retrieves the requested data from the data storage and supplies the retrieved data to said one of the computers.

11. The data exchange system according to claim 8, wherein the computer switcher further has a connection terminal connected to the interface controller and configured to receive an external storage medium storing data to be shared among the computers, and wherein the interface controller retrieves the requested data in the external storage medium via the connection terminal.

12. The data exchange system according to claim 8, wherein the data exchanger of each computer further generates a parameter setup request, and wherein the interface controller receives the parameter setup request from said one of the computers and causes a designated computer to set up a parameter based on the parameter setup request.

13. A data exchange method carried out among a plurality of computers connected to a computer switcher, the method comprising the steps of:
generating a data transfer request in one of the computers;
sending the data transfer request to the computer switcher;
obtaining requested data at the computer switcher; and
supplying the obtained data to said one of the computer.

14. The method according to claim 13, further comprising the steps of:
supplying the data transfer request from the computer switcher to a designated computer;
causing the designated computer to retrieve data requested by said one of the computers; and
receiving the retrieved data at the computer switcher from the designated computer.

15. The method according to claim 13, further comprising the steps of:
causing the computer switcher to retrieve data requested by said one of the computers from a data storage.

16. The method according to claim 13, further comprising the steps of:
generating a parameter setup value in one of the computers;
supplying the parameter setup value to a designated computer via the computer switcher; and
causing the designated computer to set up a parameter based on the parameter setup value.

17. A data exchange program installable in a computer connected to a computer switcher, the program comprising the instructions of:
causing the computer to generate a data transfer command requesting a designated computer to transfer target data to the computer;
causing the computer to transmit the data transfer command to the designated computer via the computer switcher; and
causing the computer to receive the target data from the designated computer via the computer switcher.

18. A data exchange program installable in a computer connected to a computer switcher, the program comprising the instructions of:
causing the computer to generate a data transfer command requesting the computer switcher to retrieve target data from a data storage;
causing the computer to send the data transfer command to the computer switcher; and
causing the computer to receive the desired data from the computer switcher.

19. A data exchange program installable in a computer connected to a computer switcher, the program comprising the instructions of:
causing the computer to generate a parameter setup value designating a second computer connected to the computer switcher; and
causing the computer to send the parameter setup value to the second computer via the computer switcher in order to set up a parameter in the second computer based on the parameter setup value.

20. The data exchange program according to claim 19, further comprising the instructions of:
causing the computer to receive a parameter setup value generated by the second computer; and
causing the computer to set up a parameter based on the received parameter setup value.

21. The data exchange program according to claim 19, further comprising the instructions of:
causing the second computer to receive the parameter setup value generated by the computer; and
causing the second computer to set up the parameter based on the received parameter setup value.
